(19) United States
(12) Patent Application Publication
(10) Pub. No.: US 2018/0142848 A1
(43) Pub. Date: May 24, 2018

(54) WALL-MOUNTED LUMINAIRE

(71) Applicant: Luca SANDONA', Padova (IT)

(72) Inventor: Luca SANDONA', Padova (IT)

(21) Appl. No.: 15/814,995

(22) Filed: Nov. 16, 2017

(30) Foreign Application Priority Data
Nov. 24, 2016 (IT) 102016000118867

(51) Int. Cl. F21S 8/00; F21V 21/02; H02G 3/10

(52) U.S. Cl. CPC F21S 8/036; H02G 3/105; F21V 21/02

(57) ABSTRACT

A wall-mounted luminaire, having
a supporting part for an electrically powered element,
at least one predominantly longitudinally extended part for fixing to a wall and for covering the power supply cable, which is adapted to support in a cantilever manner, at a first end, the supporting part. The wall-mounted luminaire further includes
the predominantly longitudinally extended part being provided with a space for the passage of an electric power supply cable. The passage space extends from the first end to a region proximate to the second opposite end of the predominantly longitudinally extended part.

### CROSS REFERENCED TO RELATED APPLICATIONS

This application is related to and claims the benefit of Italian Patent Application No. 102016000118867, filed on Nov. 24, 2016, the contents of which are herein incorporated by reference in their entirety.

### TECHNICAL FIELD

The present disclosure relates to a wall-mounted luminaire BACKGROUND

Currently, in civil and industrial buildings wall-mounted external lighting is provided by means of lamp holders which are installed so as to be placed against a wall at a certain distance from a corner of the building itself.

These lamp holders therefore allow to arrange a lamp so that it lights substantially only the face of the building to which the lamp holder is fixed.

This situation is determined by the fact that the electrical cables is required for the power supply of an outdoor wall-mounted lamp exit from said wall at a certain distance from a corner of the building, generally between 20 cm and 50 cm depending on the thickness of the walls.

These known lamp holders, despite being widespread and appreciated, an example of which is shown in FIG. 1 and designated therein by the letter A, have the important limitation of allowing the lighting only of the face B of the building C to which they are fixed; in order to light two faces of two walls that converge in a same corner of a building it is therefore necessary to install two lamp holders, one for each of the faces to be lit.

Supporting systems for lamps at a corner of a building are currently known which comprise metallic brackets to be applied astride the corner and on which the lamp is applied.

With such a supporting system, the electric power supply cable remains visible between the exit hole from a wall, normally arranged at a distance between 20 cm and 50 cm from the corner of the building, or is protected by means of visible conduits up to the metallic bracket, and then extends exposed up to the lamp and either hangs or is fixed with other known makeshift means such as ties and the like.

Therefore, such a lamp supporting system creates a situation of lack of protection for the electrical cable and at the same time has a low visual impact for the wall of the building, on which the protective conduit remains visible in relief.

A second important limitation of metallic supporting brackets arranged astride a corner of a building is constituted by the fact that the fixing of these brackets to converging walls is generally performed by means of screw anchors; this solution is highly risky for the integrity of the corner of the building, since drilling and placing screw anchors proximate to a corner can cause the forming of cracks on the two converging faces, cracks which render the corner itself fragile with the risk of pieces detaching.

Furthermore, often the application of the angular metallic brackets is not a feasible solution, since generally at a corner of a building there is the vertical drain pipe of the roof gutters, and wall fixing in that region is prevented by the space occupation of the vertical pipe.

### SUMMARY

The aim of the present disclosure is to provide a wall-mounted luminaire that is capable of improving the background art in one or more of the aspects indicated above.

Within this aim, the disclosure provides a luminaire that is capable of allowing better and greater lighting at a corner of a building.

The disclosure also provides a luminaire the electric power supply cables of which are better protected with respect to known solutions.

The disclosure further provides a luminaire that can be installed without risks for the integrity of a building corner to which said luminaire is applied.

The disclosure also provides a luminaire that can be installed even in the presence of a vertical gutter pipe.

The disclosure further provides a luminaire that has a better visual impact than supporting systems of the known type.

The disclosure also provides a luminaire that is capable of allowing better and greater lighting at a corner of a building even in the presence of contiguous walls that are not perfectly perpendicular.

Moreover, the present disclosure overcomes the drawbacks of conventional luminaires.

This aim, as well as these and other advantages which will become better apparent hereinafter, are achieved by providing a wall-mounted luminaire having a supporting part for an electrically powered element, at least one predominantly longitudinally extended part for fixing to a wall and for covering the power supply cable, which is adapted to support in a cantilever manner, at a first end, said supporting part, said at least one predominantly longitudinally extended part being provided with a space for is the passage of an electric power supply cable, said passage space extending from said first end to a region proximate to the second opposite end of said predominantly longitudinally extended part, optionally provided with one or more of the characteristics of the dependent claims.

### BRIEF DESCRIPTION OF THE DRAWINGS

Further characteristics and advantages of the disclosure will become better apparent from the description of two preferred but not exclusive embodiments of the wall-mounted luminaire according to the disclosure, illustrated by way of non-limiting examples in the accompanying drawings, wherein:

FIG. 1 is a view of a wall-mounted lamp holder of the known type;

FIG. 2 is a luminaire according to the disclosure in a first embodiment thereof;

FIG. 3 is a schematic sectional top view of a luminaire according to the disclosure in the first embodiment of FIG. 2;

FIG. 4 is a perspective view of a luminaire according to the disclosure in a second embodiment;

FIG. 5 is another perspective view of a portion of the luminaire of FIG. 4;

FIG. 6 is a view of a constructive variation of the second embodiment of a luminaire according to the disclosure;

FIG. 7 is a view of a constructive variation of the first embodiment of a luminaire according to the disclosure;

FIG. 8 is a view of another variation of the first embodiment of a luminaire according to the disclosure;

FIG. 9 is an exploded perspective view of another variation of the second embodiment of the disclosure; and

FIG. 10 is an overall plan view of the variation of FIG. 9.

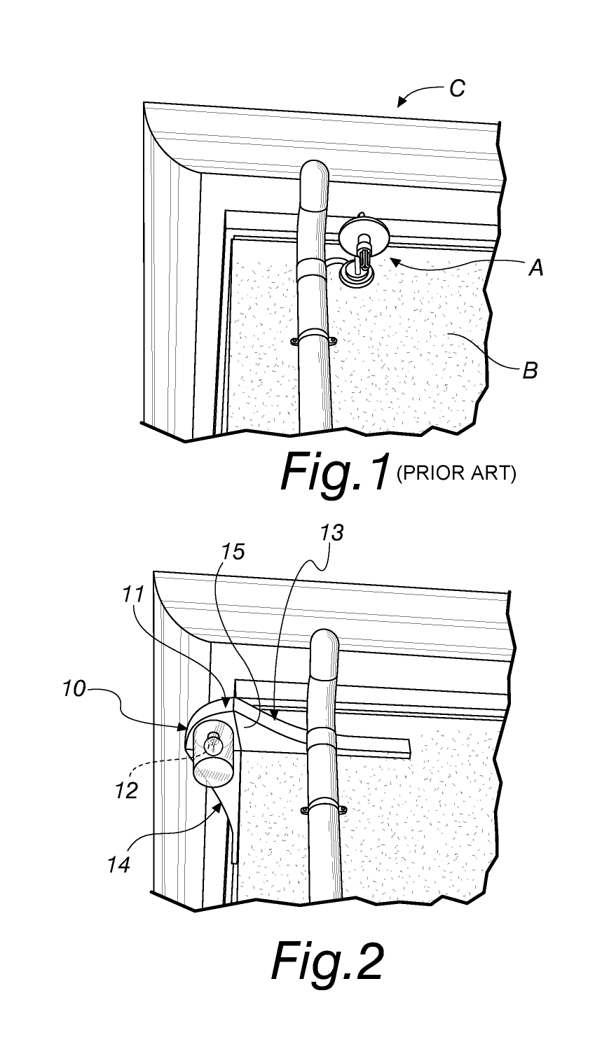

### DETAILED DESCRIPTION OF THE DRAWINGS

With reference to the figures, a wall-mounted luminaire according to is the disclosure is designated generally, in its first embodiment, by the reference numeral 10.

The wall-mounted luminaire 10 comprises
a supporting part 11 for an electrically powered element, for example a lamp 12,
two predominantly longitudinally extended parts 13 and 14 for fixing to a wall and for covering the power supply cable, which are adapted to support in a cantilever manner, at a first end 15 and 15a respectively, the supporting part 11.

A predominantly longitudinally extended part, for example a first longitudinally extended part 13, has a passage space 17 for an electric power supply cable 18.

The passage space 17 is extended from the first end 15 to a region proximate to the second opposite end 16 of the predominantly longitudinally extended part 13.

The luminaire 10, in the present first embodiment, has two predominantly longitudinally extended parts 13 and 14 which are arranged so as to be both extended from the supporting part 11, so as to form between them an angle that corresponds to the angle 19 that is defined by the intersection of the planes of arrangement X and Y of two converging walls 20 and 21 to which the luminaire 10 is fixed.

By virtue of this structure, the luminaire 10 supports a lamp 12 in a cantilever fashion in the angular sector formed by the corner 19, so that the lamp 12 can light both converging walls 20 and 21, for an overall lighting angle of approximately 270°, if the converging walls 20 and 21 are at 90° with respect to each other, with respect to an angle of 180° that is typical of known wall-mounted lamp holders.

In the present constructive example, a lamp 12 has been indicated as an electrically powered element, it being understood that the electrically powered element may also be a sign or a video camera or a sensor in general or another similar and equivalent device.

In the position determined by the luminaire 10 according to the disclosure, the electrically powered element that is supported by the supporting part 11 is placed in the condition to operate on both of the faces of the converging walls 20 and 21.

The supporting part 11 is constituted, for example, by a containment shell for the electrical connections between the electrical cable 18 and the electrically powered element, for example the lamp 12, provided with two lateral openings 22 and 23 preset to face the corresponding predominantly longitudinally extended parts 13 and 14.

The supporting part 11 is fixed to the predominantly longitudinally extended parts 13 and 14 for example by virtue of snap coupling means 24 and 25, which are to be understood as being of a known type.

Each predominantly longitudinally extended part 13 and 14 is fixed to a wall, for example by virtue of snap coupling means, also of a per se known type, comprising two contoured blocks 26 and 27 to be fixed, in a mutually spaced arrangement, to a wall, and corresponding complementarily shaped coupling portions formed inside the predominantly longitudinally extended part 13 and 14.

The contoured blocks 26 and 27 must be appropriately mounted at a safe distance from the corner 28 of the converging walls 20 and 21, so that even if they are fixed by using screw anchors the operations for drilling and inserting the screw anchors do not risk damaging the integrity of the corner 28.

Advantageously, the predominantly longitudinally extended part 13 and 14 has a flat portion 31 and 32 respectively, preset to be arranged at a gutter pipe 33 if present, between the wall 20 and the gutter pipe 33, thus providing the protection and covering of the electrical cable 18 even in a particularly awkward space situation such as the one presented.

These predominantly longitudinally extended parts 13 and 14 are is constituted for example by shells made of plastic material which are open on a first side designed to face the wall 20 and 21 and on a second side, perpendicular to the first one, designed to face the supporting part 11 and be coupled to it.

It should be understood that the supporting parts 11 and predominantly longitudinally extended parts 13 and 14 can also be made of other materials, for example metallic material, according to the requirements and needs.

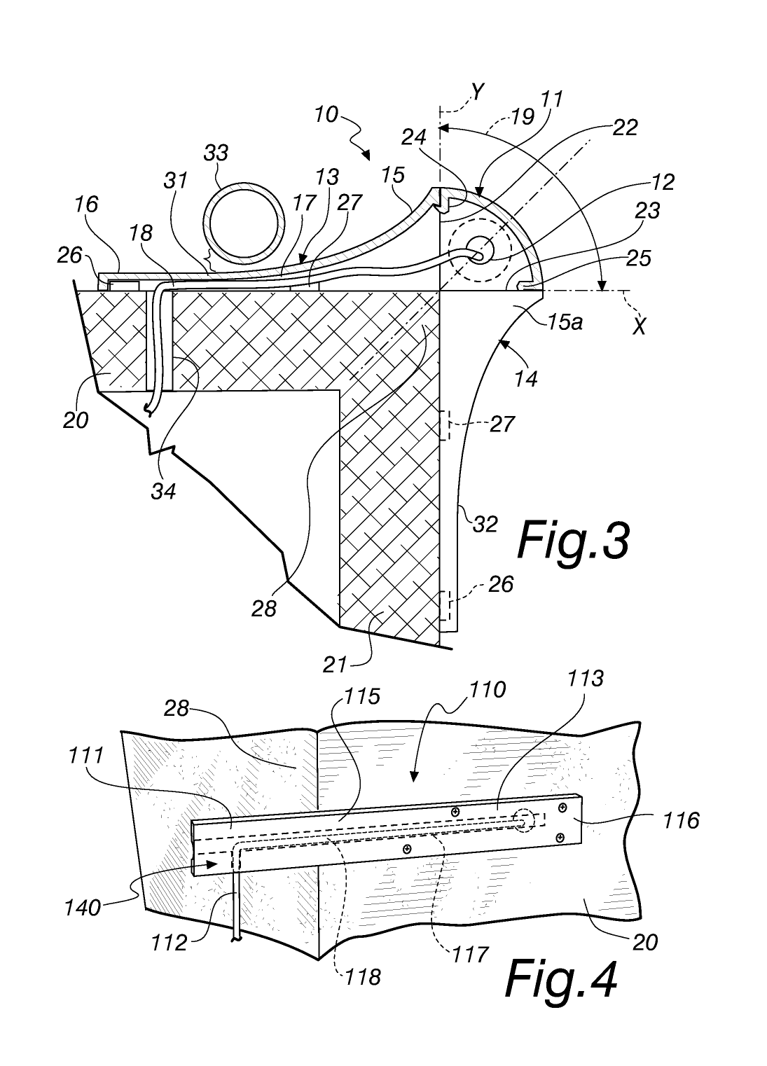

FIG. 3, for the sake of completeness, describes a hole 34 in a wall 20, for passage from the inside outward for the electrical cable 18.

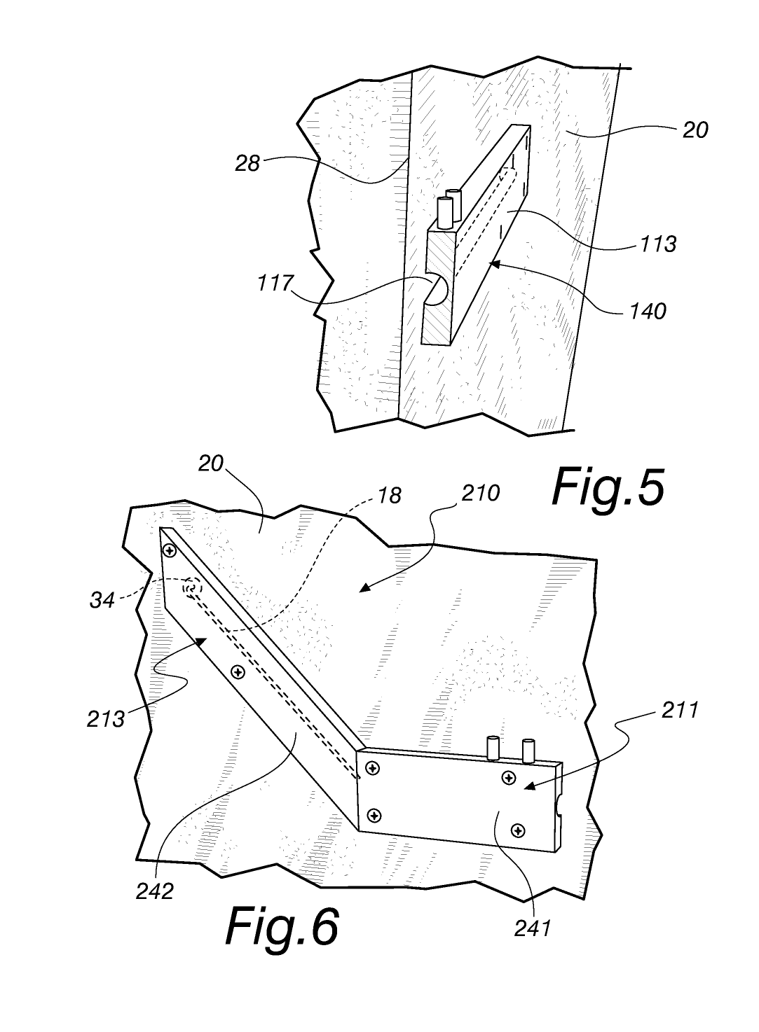

FIGS. 4 and 5 show a luminaire according to the disclosure in a second embodiment.

In the second embodiment, the wall-mounted luminaire, designated by 110, comprises
a supporting part 111 for an electrically powered element, for example a lamp 112,
and a single predominantly longitudinally extended part 113, for fixing to a wall and for covering the power supply cable, which is adapted to support in a cantilever manner, as a first end 115 thereof, the supporting part 111,

such predominantly longitudinally extended part 113 having a passage space 117 for an electric power supply cable 118, the passage space 117 extending from the first end 115 to a region proximate to the second opposite end 116 of the predominantly longitudinally extended part 113.

In this second embodiment, the supporting part 111 and the predominantly longitudinally extended part 113 are monolithic.

In particular, the supporting part 111 and the predominantly longitudinally extended part 113 are formed by a single plate 140, which can be fixed to a wall 20 with screw anchors, appropriately spaced from the corner 28.

In a constructive variation of the second embodiment of the luminaire is according to the disclosure, designated by the numeral 210 in FIG. 6, the supporting parts 211 and the predominantly longitudinally extended part 213 are two distinct pieces.

In particular, the supporting part 211 and the predominantly longitudinally extended part 213 are formed by two distinct plates 241 and 242, which can be fixed to the wall 20 by means of screw anchors, appropriately spaced from the corner 28, each of the plates 241 and 242 extending in different and converging directions.

By virtue of such a structure it is possible to arrange the electrically powered element supported by the luminaire 210 at a height from the ground that is different with respect to the height of the exit hole 34 of the electrical cable 18.

FIG. 7 shows a first constructive variation of the first embodiment of the luminaire according to the disclosure, designated therein by the reference numeral 310.

Whereas in the first embodiment of the luminaire 10, of FIGS. 2 and 3, the predominantly longitudinally extended parts 13 and 14 are arranged on a same plane of arrangement which is perpendicular to both of the converging walls 20 and 21 and is substantially horizontal, in the first variation of FIG. 7 the predominantly longitudinally extended parts 313 and 314 are each arranged on a plane that is inclined with respect to a horizontal reference plane.

With this luminaire 310 also it is possible to arrange the electrically powered element at a height from the ground that is different with respect to the height of the exit hole 34 of the electrical cable 18.

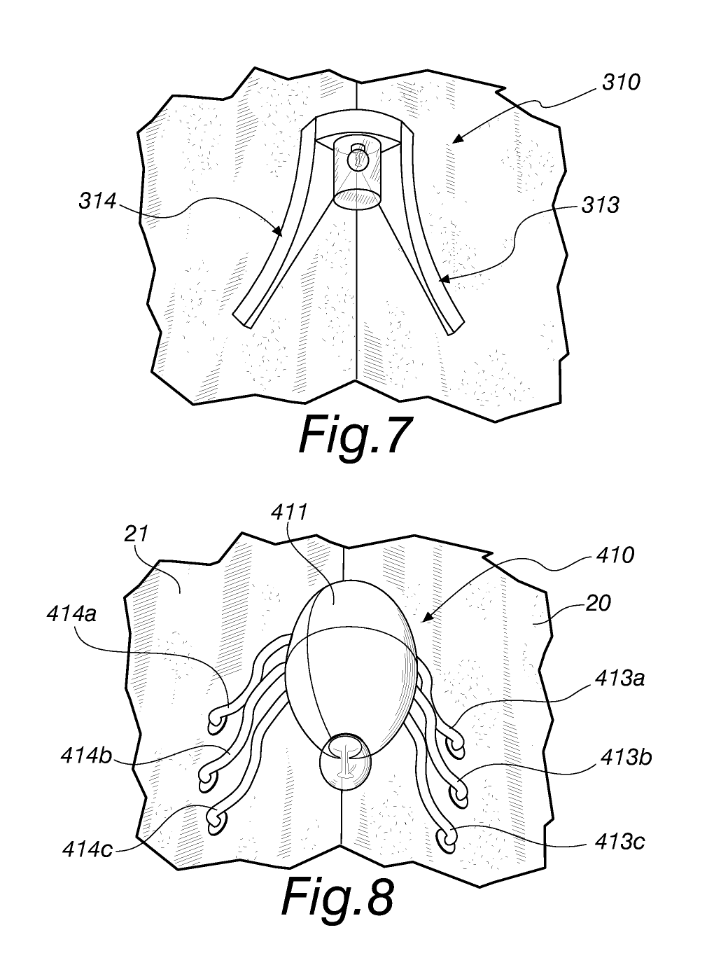

FIG. 8 shows a second constructive variation of the first embodiment of the luminaire according to the disclosure, designated therein by the numeral 410.

In this variation, the luminaire 410 comprises a supporting part 411 for an electrically powered element, and more than one predominantly longitudinally extended part, for example three, 413a, 413b, 413c, and 414a, 414b and 414c, for each one of the converging walls 20 and 21.

The luminaire 10, 110, 210, 310, 410, although described for outdoor applications, obviously is to be understood as applicable also at corners between internal walls.

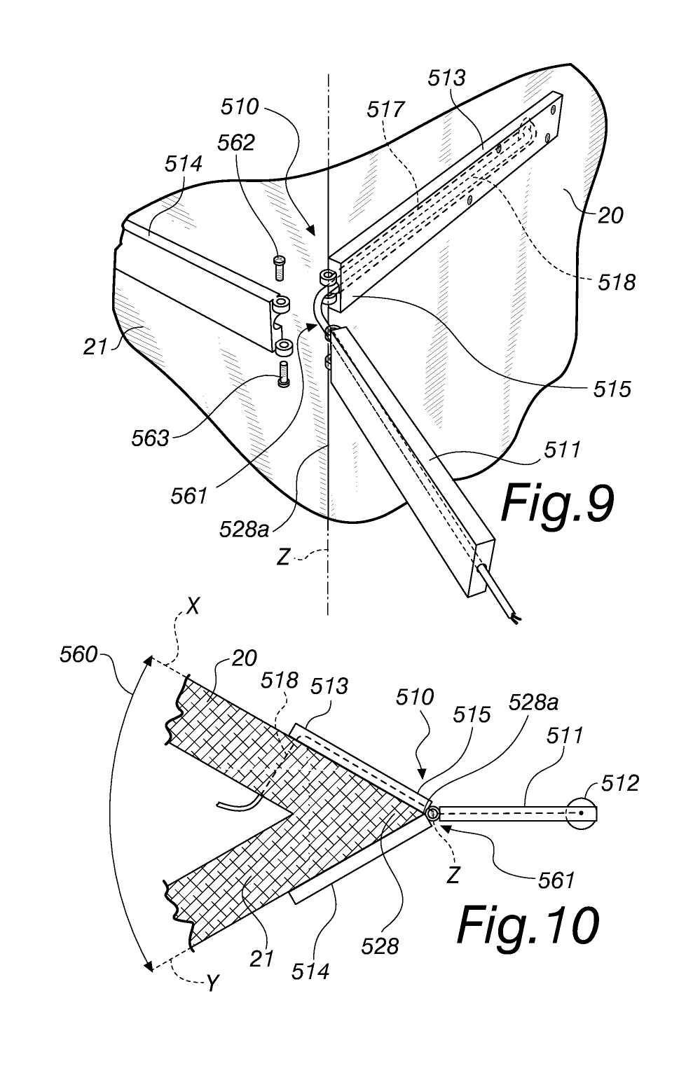

FIGS. 9 and 10 show another variation of the second embodiment of the luminaire according to the disclosure, designated therein by the numeral 510.

The wall-mounted luminaire 510 comprises:
a supporting part 511 for an electrically powered element, for example a lamp 512,
at least one predominantly longitudinally extended part 513, and for example two predominantly longitudinally extended parts 513 and 514, for fixing to a wall and for covering the power supply cable, which is adapted to support in a cantilever manner, at a first end 515 thereof, the supporting part 511.

At least one predominantly longitudinally extended part, for example 513, has a passage space 517 for an electric power supply cable 518, as already described above for the second embodiment.

The luminaire 510 has the particularity of comprising two predominantly longitudinally extended parts 513 and 514 which are rotatably coupled to each other and to the supporting part 511, about an axis Z which is substantially parallel to the line 528a of the corner 528, so as to adapt the mutual angular arrangement to the actual angle 560 that is defined by the intersection of the planes of arrangement X and Y of two converging walls 20, 21 to which the luminaire 510 is fixed.

In the example described and shown in FIGS. 9 and 10, the actual angle 560 is less than 90°.

The rotatable coupling between the predominantly longitudinally extended parts 513 and 514 and the supporting part 511 is constituted for is example by a coaxial bush hinge 561, with a pivot that can be formed by one or more locking screws 562 and 563.

In practice it has been found that the disclosure achieves the intended aim and objects.

In particular, the disclosure provides a luminaire capable of allowing better and greater lighting at a corner of a building, by virtue of the possibility to arrange a lamp at the very corner of a building, so as to light two converging sides of the building with a single luminaire.

Moreover, the disclosure provides a luminaire the electric power supply cables of which are better protected with respect to known solutions.

Furthermore, the disclosure provides a luminaire that can be installed without risks for the integrity of a corner of a building to which the luminaire is applied.

Moreover, the disclosure provides a luminaire that can be installed even in the presence of a vertical gutter pipe.

Furthermore, the disclosure provides a luminaire that can be installed easily at the corner of a building even in the presence of contiguous walls that are not perfectly perpendicular.

Furthermore, the disclosure provides a luminaire that has a better visual impact than supporting systems of the known type, by virtue of the broad possibility of aesthetic shapes that it is possible to give to its various parts.

The disclosure thus conceived is susceptible of numerous modifications and variations, all of which are within the scope of the appended claims; all the details may furthermore be replaced with other technically equivalent elements.

In practice, the components and materials used, so long as they are compatible with the specific use, as well as the contingent shapes and dimensions, may be any according to the requirements and the state of the art.

1. A wall-mounted luminaire, comprising:
a supporting part for an electrically powered element,
at least one predominantly longitudinally extended part configured for fixing to a wall and for covering the power supply cable, which is adapted to support in a cantilever manner, at a first end, said supporting part,
said at least one predominantly longitudinally extended part being provided with a space for the passage of an electric power supply cable, said passage space extending from said first end to a region proximate to the second end, opposite the first end, of said predominantly longitudinally extended part.

2. The luminaire according to claim 1, further including two predominantly longitudinally extended parts arranged such that both longitudinally extended parts extend from the supporting part, and form between the extended parts an angle that corresponds to the angle formed by the intersection of the planes of arrangement of two converging walls to which the luminaire is fixed.

3. The luminaire according to claim 2, wherein the luminaire supports a cantilever lamp-in the angular sector formed by said angle, such that said lamp lights the two converging walls, for an overall lighting angle of approximately 270°, if the converging walls are at 90° with respect to each other.

4. The luminaire according to claim 1, wherein said electrically powered element is a sign, a video camera, a sensor, or a similar and equivalent device.

5. The luminaire according to claim 1, wherein the supporting part is fixed to the at least one predominantly longitudinally extended parts with snap coupling means.

6. The luminaire according to claim 1, wherein each predominantly longitudinally extended part is fixed to a wall by virtue of snap coupling means, comprising two contoured blocks to be fixed, mutually spaced, to a wall, and corresponding complementarily shaped coupling portions formed inside the predominantly longitudinally extended part.

7. The luminaire according to claim 1, wherein said predominantly longitudinally extended part is provided with a flat portion.

8. The luminaire according to claim 1, wherein said predominantly longitudinally extended part is constituted by shells made of plastic material which are open on a first side configured to face the wall and, on a second side which is perpendicular to the first side, configured to face and be coupled to the supporting part.

9. The luminaire according to claim 1, wherein said supporting part and the predominantly longitudinally extended part are monolithic.
